(19) United States
(12) Patent Application Publication
(10) Pub. No.: US 2025/0046505 A1
(43) Pub. Date: Feb. 6, 2025

(54) INDUCTOR

(71) Applicant: Panasonic Intellectual Property Management Co., Ltd., Osaka (JP)

(72) Inventors: Kiyoshi TAKAGI, Hyogo (JP); Yusuke NAKAMURA, Hyogo (JP); Masahiro ENOMOTO, Osaka (JP); Hiroshi TOMITA, Nara (JP); Satoru SHIMOMURA, Hyogo (JP)

(73) Assignee: Panasonic Intellectual Property Management Co., Ltd., Osaka (JP)

(21) Appl. No.: 18/836,656

(22) PCT Filed: Feb. 27, 2023
(86) PCT No.: PCT/JP2023/007037

§ 371 Date: Aug. 7, 2024

(30) Foreign Application Priority Data
Feb. 28, 2022 (JP) 2022-028804

(51) Int. Cl. H01F 27/24; H01F 27/29

(52) U.S. Cl. CPC H01F 27/24; H01F 27/29

(57) ABSTRACT

An inductor includes a magnetic core obtained by pressure-molding a mixture of a magnetic material powder and a binding agent, and coil elements buried in the magnetic core. The coil elements include two tabular coils that are a first coil element and a second coil element provided overlappingly in stated order from a first side face side to a second side face side. End portions of the coil elements protrude from the bottom face and are bent along the bottom face to configure external electrodes. One of first external electrodes extends toward a first end face and an other one of the first external electrodes extends toward the second end face, and second external electrodes extend toward a second side face.

### TECHNICAL FIELD

The present invention relates to inductors to be used in power supply circuits, and so on.

### BACKGROUND ART

In recent years, with the advancement of voltage reduction for large-scale integrated circuits such as CPUs, and the like, there has been a demand for small, low-profile power supply circuits in which the required current needed by an element reaches up to several tens of amperes. In order to deal with high current, the multiphase power supply method has found mainstream use. For this reason, as a power supply method that corresponds to this method, the coupling method is being used. An inductor used in this coupling method is driven by an inductor in which a plurality of coils are connected with a coupling coefficient of about 0.6.

It should be noted that, as patent literature information related to the invention of this application, Patent Literature 1, for example, is known.

### CITATION LIST

### Patent Literature

[PTL 1] Japanese Unexamined Patent Application Publication No. 2008-235773

### SUMMARY OF INVENTION

### Technical Problem

However, when higher current is further demanded, the conventional coupling method has limitations. In response to this, a method referred to as multiphase regulator is being studied. In the case of this method, the connection between a plurality of coils needs to be significantly enlarged, and sufficient characteristics could not be obtained with inductors used in the coupling method. In order to increase the coupling coefficient, the opposed areas between coils needs to be increased, and electrode extraction as in conventional coupled inductors was difficult to carry out. Furthermore, in such a method, a plurality of inductors needed to be arranged in a line, and deterioration of electrical characteristics caused by a line connecting the inductors also occurred.

The present invention has as an object to provide an inductor that is small, capable of dealing with high current, easy to wire, and has a big coupling coefficient.

### Solution to Problem

In order to solve the aforementioned problem, the present invention is an inductor including: a magnetic core that is in a shape of a rectangular parallelepiped obtained by pressure-molding a mixture of a magnetic material powder and a binding agent; and coil elements buried in the magnetic core, wherein the magnetic core includes a bottom face, a top face located opposite to the bottom face, a first end face connecting the bottom face and the top face, a second end face located opposite to the first end face, a first side face connecting the bottom face and the top face, and a second side face located opposite to the first side face, the magnetic core being rectangular in shape when seen from the top face, the first end face and the second end face are provided on short sides of the magnetic core, and the first side face and the second side face are provided on long sides of the magnetic core, the coil elements include two tabular coils that are a first coil element and a second coil element provided overlappingly in stated order from a first side face-side to a second side face-side, end portions of the coil elements protrude from the bottom face and are bent along the bottom face to configure external electrodes, the external electrodes connected to the first coil element are first external electrodes, and the external electrodes connected to the second coil element are second external electrodes, among the end portions, end portions of the first coil element are bent toward the first side face, and end portions of the second coil element are bent toward the second side face, and one of the first external electrodes extends toward the first end face and an other one of the first external electrodes extends toward the second end face, and the second external electrodes extend toward the second side face.

### Advantageous Effects of Invention

According to the above-described configuration, it is possible to provide an inductor that is small, capable of dealing with high current, easy to wire, and has a big coupling coefficient

### BRIEF DESCRIPTION OF DRAWINGS

FIG. 1 is a perspective view of an inductor according to an embodiment of the present invention.

FIG. 2 illustrates external views of an inductor according to an embodiment of the present invention.

FIG. 3 illustrates plan views of coil elements according to an embodiment of the present invention.

FIG. 4 is a top view of a substrate onto which the inductor according to an embodiment of the present invention is mounted.

### DESCRIPTION OF EMBODIMENTS

Hereinafter, an inductor according to an embodiment of the present invention shall be described with reference to the Drawings.

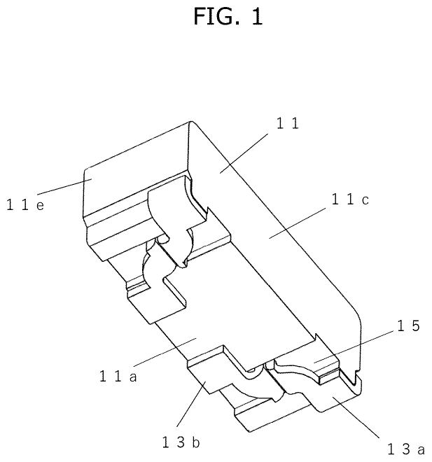

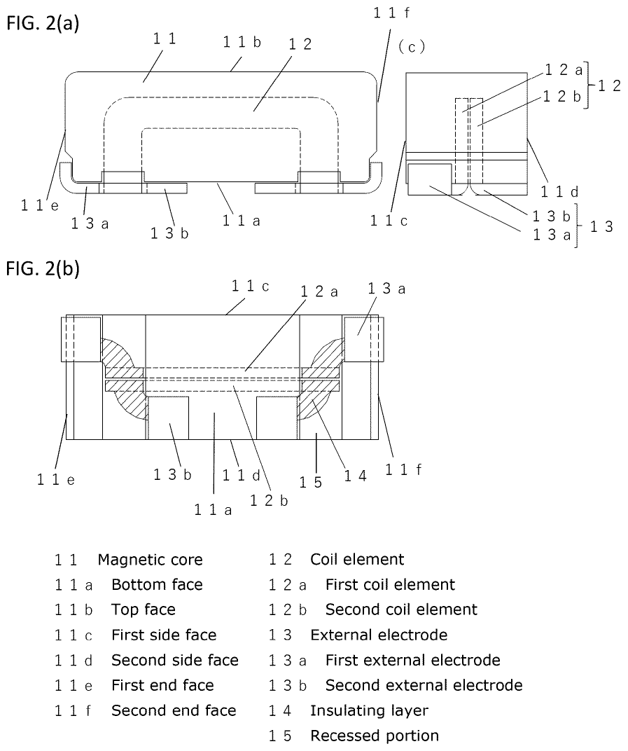

FIG. 1 is a perspective view seen from the bottom face side of the inductor according to an embodiment of the present invention, and FIG. 2 illustrates external views of the inductor according to an embodiment of the present invention; (a) in FIG. 2 is an external view of a side face of the inductor according to an embodiment of the present invention, (b) in FIG. 2 is an external view of the bottom face of the inductor, and (c) in FIG. 2 is an external view of an end face of the inductor. It should be noted that, in FIG. 2, coil elements are indicated by broken lines.

The inductor according to an embodiment of the present invention includes rectangular parallelepiped magnetic core 11 obtained by mixing a magnetic material powder made of Fe—Si—Cr powder and a binding agent made of silicone, then pressure-molding the mixture, and coil elements 12 that is buried in magnetic core 11. The external shape of magnetic core is rectangular parallelepiped with a width of approximately 6 mm, a length of approximately 13 mm, and a height of approximately 5 mm, and is rectangular with a width of approximately 6 mm, a length of approximately 13 mm when seen from above. Magnetic core 11 includes bottom face 11a from which end portions of coil elements 12 protrude, top face 11b located opposite bottom face 11a, first end face 11e that connects bottom face 11a and top face 11b and is provided at a part that serves as a short side when seen from the top face 11b-side, second end face 11f located opposite first end face 11e, first side face 11c provided in a part that serves as a long side, and second side face 11d located opposite first side face 11c.

Two tabular coil elements 12 are buried inside magnetic core 11, that is, first coil element 12a and second coil element 12b are buried in stated order from the first side face 11c-side to the second side face 11d-side of magnetic core 11 so as to overlap and oppose each other in the aforementioned face direction. The end portions of the respective coils protrude from bottom face 11a of magnetic core 11 and bend along bottom face 11a to configure external electrodes 13. Each of coil elements 12 is formed by stamping out a copper plate, and has a thickness of approximately 0.4 mm and a coil pattern width of approximately 0.8 mm. Furthermore, an approximately 0.03 mm-thick insulating layer made of epoxy resin, phenolic resin, acrylic resin, or the like, is provided, by pad printing or the like, on the surface of the portions of coil elements 12 that are buried in magnetic core 11.

Here, external electrodes 13 that are connected to first coil element 12a are referred to as first external electrodes 13a, and external electrodes 13 that are connected to second coil element 12b are referred to as second external electrodes 13b. The end portions of first coil element 12a are bent toward first side face 11c to configure first external electrodes 13a, and the end portions of second coil element 12b are bent toward second side face 11d to configure second external electrodes 13b. In addition, the tip portion of one first external electrode 13a extends toward first end face 11e, and the tip portion of the other first external electrode 13a extends toward second end face 11f. Furthermore, the tip portions of second external electrodes 13b both extend toward second side face 11d.

In addition, the tip of first external electrode 13a is bent along first end face 11e or second end face 11f. This is more preferable because doing so facilitates the forming of solder fillets from first external electrodes 13a during mounting, and thus makes it possible to improve the fixing strength of the inductor as well as the visibility of the state of the soldering. On the other hand, it is preferable that second external electrodes 13b are not bent along second side face 11d. By doing so, solder fillet is not easily formed on the second side face 11d-side, and thus making it possible to allow high-density mounting.

Furthermore, in bottom face 11a of magnetic core 11, recessed portions 15, which are approximately 0.4 mm deep, are provided in regions that include the protruding portions of coil elements 12 and connect first side face 11c and second side face 11d. When the end portions of coil elements 12 are made to protrude from bottom face 11a and then bent along bottom face 11a, bulges are inevitably formed at the bent portions, which diminishes stability during mounting. In view of this, by making the end portions of coil elements 12 protrude from recessed portions 15 provided in bottom face 11a of magnetic core 11 as in the present embodiment, the flatness of the mounting surface of the inductor can be improved. The depth of recessed portion 15 is preferably at least 80% and at most 200% of the thickness of external electrodes 13. When the depth of the recessed portions is less than 80% of the thickness of the external electrodes, flatness deteriorates. Conversely, when the depth exceeds 200%, the volume of the core becomes small and impedance value decreases, and is therefore undesirable.

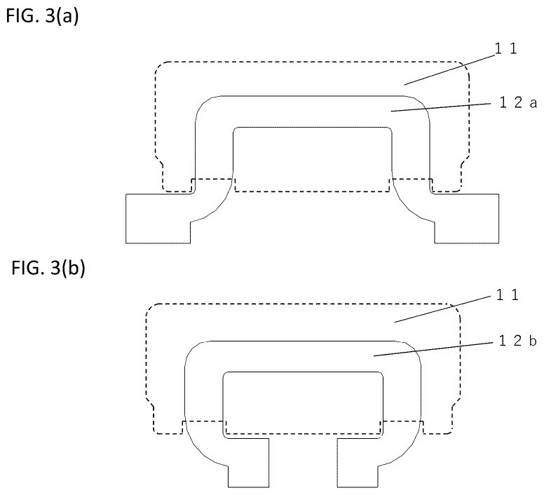

Here, coil elements 12 will be described in more detail. FIG. 3 illustrate plan views of the coil elements according to an embodiment of the present invention; (a) in FIG. 3 is a plan view of first coil element 12a, and (b) in FIG. 3 is a plan view of second coil element 12b. In FIG. 3, the external shape of magnetic core 11 when these coil elements are buried in magnetic core 11 is indicated by broken lines. The end portions of the coil elements that protrude outside of the broken lines configure outer electrodes 13 by being bent along bottom face 11a after the coil elements are buried. At this time, the portions of the two coil elements that are buried in magnetic core 11 overlap, and the portions that configure external electrodes 13 do not overlap. For this reason, the connection between first coil element 12a and second coil element 12b at the portion buried in magnetic core 11 can be strengthened, and the portions that become external electrodes 13 can be easily bent toward opposite sides. It should be noted that although the loop of the coils is rectangular in shape in FIG. 3, the loop may be in a rounded 2-shape.

With the above described configuration, the end portions of first coil element 12a and the end portions of second coil element 12b come close and protrude from magnetic core 11 at bottom face 11a, and thus short circuiting tends to occur during mounting. In view of this, it is preferable that insulating layer 14 is also provided in the regions at which the end portions of first coil element 12a and the end portions of second coil element 12b protrude from magnetic core 11. It should be noted that in (b) in FIG. 2, in order to facilitate understanding, slanted lines are applied to the portions where insulating layer 14 is provided. It is preferable that this insulating layer 14 is provided at the same time when the insulating layer is formed on the portions of the coil elements that are buried in magnetic core 11. By doing so, the manufacturing process can be simplified. Furthermore, when seen from the first side face 11c-side, it is further preferable that the regions of respective external electrodes 13 where insulating layer 14 is not provided do not overlap. By doing so, short-circuiting is not likely to occur even when a plurality of inductors are mounted in high-density, which is therefore more desirable.

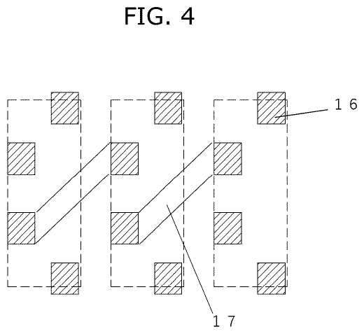

FIG. 4 is a top view of a substrate for mounting the inductor according to an embodiment of the present invention. In the substrate, lands 16 are provided for mounting a plurality of inductors, and are electrically connected to each other inside the substrate by lines 17. In FIG. 4, the positions at which inductors are to be mounted are indicated by broken lines, and slanting lines are applied to the portions denoting lands 16. By mounting inductors on such a substrate, second coil elements 12b of the plurality of inductors can be connected in series. By doing so, direct current resistance between second coil elements can be reduced. In addition, since second external electrodes 13b are provided on the second side face 11d-side and not provided on the first side face 11c-side, short-circuiting does not easily occur even when adjacent inductors are mounted with reduced distance therebetween, and thus device miniaturization becomes possible.

### INDUSTRIAL APPLICABILITY

According to an inductor according to the present invention, it is possible to obtain an inductor that is small, capable of dealing with high current, and has a big coupling coefficient, and is thus industrially useful.

### REFERENCE SIGNS LIST

11 magnetic core
11a bottom face
11b top face
11c first side face
11d second side face
11e first end face
11f second end face
12 coil element
12a first coil element
12b second coil element
13 external electrode
13a first external electrode
13b second external electrode
14 insulating layer
15 recessed portion
16 land
17 line

1. An inductor comprising:
a magnetic core that is in a shape of a rectangular parallelepiped obtained by pressure-molding a mixture of a magnetic material powder and a binding agent; and
coil elements buried in the magnetic core, wherein
the magnetic core includes a bottom face, a top face located opposite to the bottom face, a first end face connecting the bottom face and the top face, a second end face located opposite to the first end face, a first side face connecting the bottom face and the top face, and a second side face located opposite to the first side face, the magnetic core being rectangular in shape when seen from the top face,
the first end face and the second end face are provided on short sides of the magnetic core, and the first side face and the second side face are provided on long sides of the magnetic core,
the coil elements include two tabular coils that are a first coil element and a second coil element provided overlappingly in stated order from a first side face-side to a second side face-side,
end portions of the coil elements protrude from the bottom face and are bent along the bottom face to configure external electrodes,
the external electrodes connected to the first coil element are first external electrodes, and the external electrodes connected to the second coil element are second external electrodes,
among the end portions, end portions of the first coil element are bent toward the first side face, and end portions of the second coil element are bent toward the second side face, and
one of the first external electrodes extends toward the first end face and an other one of the first external electrodes extends toward the second end face, and the second external electrodes extend toward the second side face.

2. The inductor according to claim 1, wherein
an insulating layer is provided on a portion of a surface of each of the external electrodes, and
when seen from the first side face-side, regions of the external electrodes that are not provided with the insulating layer do not overlap.

3. The inductor according to claim 1, wherein
a tip of each of the first external electrodes is bent along the first end face or the second end face.
